(19) United States
(12) Patent Application Publication
(10) Pub. No.: US 2015/0108202 A1
(43) Pub. Date: Apr. 23, 2015

(54) Automatic Soldering System

(71) Applicants: TYCO ELECTRONICS (SHANGHAI) CO. LTD.,, Shanghai (CN); SHENZHEN AMI TECHNOLOGY CO. LTD., Guangdong (CN)

(72) Inventors: Yingcong Deng, Shanghai (CN); Dandan Zhang, Shanghai (CN); Lvhai Hu, Shanghai (CN); Qinglong Zeng, Shenzhen Guangdong (CN)

(73) Assignees: SHENZHEN AMI TECHNOLOGY CO. LTD., Guangdong (CN); TYCO ELECTRONICS (SHANGHAI) CO. LTD., Shanghai (CN)

(21) Appl. No.: 14/519,945

(22) Filed: Oct. 21, 2014

(30) Foreign Application Priority Data
Oct. 21, 2013 (CN) 2013104936393

(51) Int. Cl. B23K 3/08; B23K 37/04; B23K 3/02

(52) U.S. Cl. CPC B23K 3/08; B23K 3/02; B23K 3/082; B23K 37/04
USPC 228/7

(57) ABSTRACT

A program controlled automatic soldering system is disclosed having a vision system, a first manipulator, and a second manipulator. The first manipulator is controlled by the vision system, and has a first gripper. The second manipulator is controlled by the vision system, and has a heater.

### CROSS-REFERENCE TO RELATED APPLICATION

This application claims priority under 35 U.S.C. §119(a)-(d) to Chinese Patent Application No. 201310493639.3, dated on Oct. 21, 2013.

### FIELD OF THE INVENTION

The invention is generally related to an automated soldering system and, more specifically, to a program controlled automated soldering system for soldering electrical elements.

### BACKGROUND

Conventionally it is very difficult to solder complicated and miniature structural features, such as conductor wires onto hundreds of tiny pins on a product. Specifically, during soldering, an operator often must use a magnifier to magnify the tiny pins, and even under assistance of the magnifier, the soldering work of the product still takes significant time and effort. Further, the operator often requires several days to complete the soldering work of single product. Furthermore, the precision of manual soldering is often very low.

Consequently, there is a need for an automated soldering system that can reliably solder intricate parts with a high degree of precision, while doing so faster than manual soldering methods.

### SUMMARY

A program controlled automatic soldering system has a vision system, a first manipulator, and a second manipulator. The first manipulator is controlled by the vision system, and has a first gripper. The second manipulator is controlled by the vision system, and has a heater.

### BRIEF DESCRIPTION OF THE DRAWINGS

The invention will now be described by way example, with reference to the accompanying Figures, of which:

FIG. 1 is a perspective view of a program controlled automatic soldering system;

FIG. 2 is a local enlarged perspective view of the program controlled automatic soldering system of FIG. 1;

FIG. 3 is a perspective view of a first manipulator of the program controlled automatic soldering system of FIG. 1; and

FIG. 4 is a perspective view of a second manipulator of the program controlled automatic soldering system of FIG. 1.

### DETAILED DESCRIPTION OF THE EMBODIMENT(S)

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

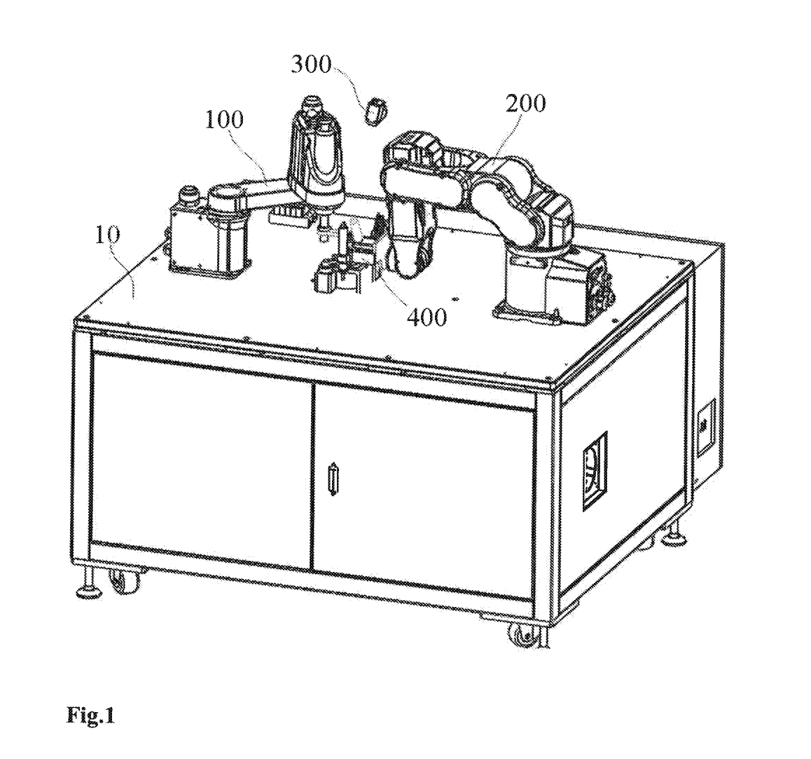

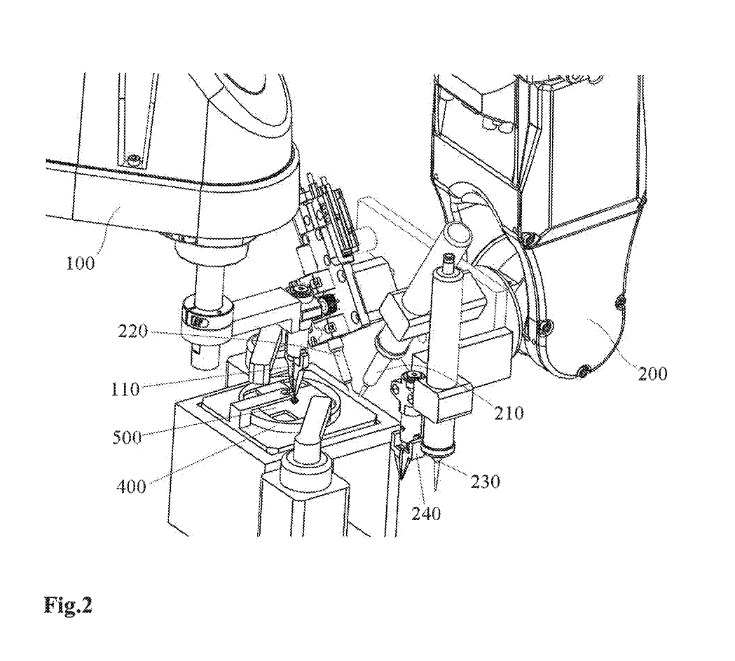

In embodiments of FIGS. 1-2, a program controlled automatic soldering system has a vision system 300, a first manipulator (first robot) 100 and a second manipulator (second robot) 200.

A gripper 110 is mounted on the first manipulator 100, allowing first manipulator 100 to grasp an object under guidance of the vision system 300 and place the object on a location where a product 500 is to be soldered.

A heater 210 is mounted on the second manipulator 200. The second manipulator 200 places a heating portion of the heater 210 on a desired location of the product 500 to heat a solder material disposed on the location of the product 500 and solder the object to the product 500.

In the embodiments of FIGS. 1-2, the first manipulator 100 and the second manipulator 200 each may be a multi-freedom robot, such as a 6-axis robot. In other embodiments, the first manipulator 100 and the second manipulator 200 may be any other type of robot known to those of ordinary skill in the art. Additionally, the first manipulator 100 and the second manipulator 200 may be the same type of robot, or may be different types of robots. In an embodiment, the robot may be a Selective Compliance Assembly Robot Arm (SCARA) robot, so that the first and second manipulators 100,200 can automatically move and cooperate with each other to perform the desired soldering work, based on a pre-programmed control program.

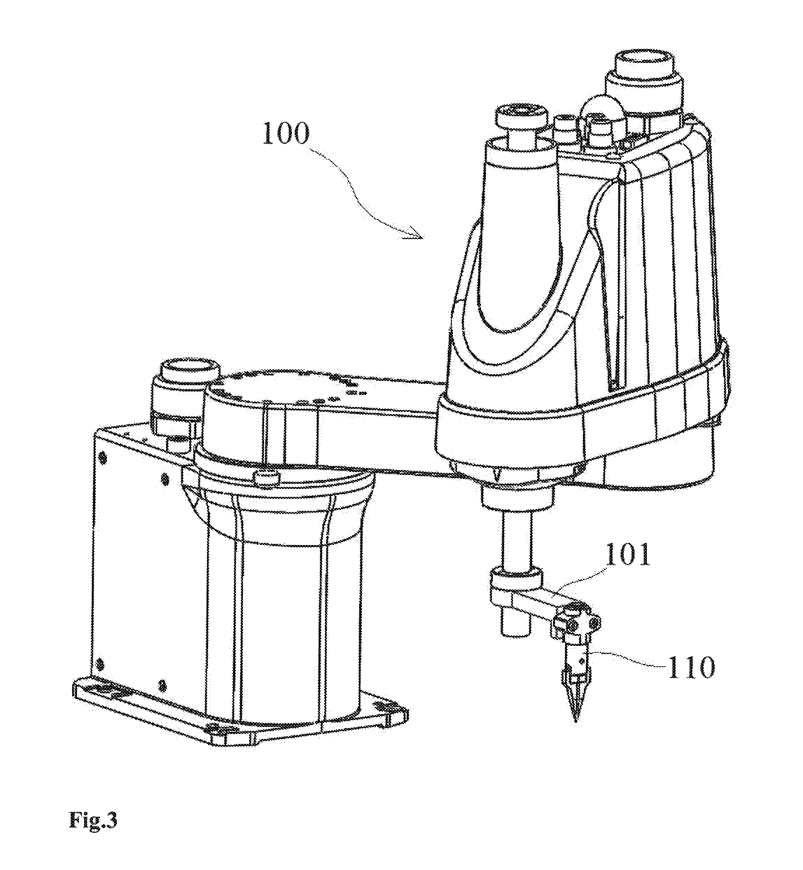

In the embodiments of FIGS. 1-3, the first gripper 110 is mounted on a first terminating arm 101 of the first robot 100. The first gripper 110 has at least opposing two fingers that open and close, so as to grip the conductor wire.

In another embodiment, a second gripper is attached to the first terminating arm 101, along with the first gripper 110. The second gripper may grasp a pin or any other type of element according to the desired application. Additionally, the first and second grippers may be the same type or may be different types.

The program controlled automatic soldering system may further comprise a product supporting base 400. The product supporting base 400 serves to hold the product 500 in place during the soldering process. An exemplary embodiment of the product 500 is a printed circuit board or any other electrical device.

In an embodiment, the program controlled automatic soldering system further includes a third gripper similar or different from the first gripper 110. The third gripper may be mounted on either the first or second manipulator 100,200. The third gripper grasps and loads the product 500 onto the product supporting base 400 under the guidance of the vision system 300 before soldering the product 500. Additionally, the third gripper may grasp and remove the product 500 from the product supporting base 400 under the guidance of the vision system 300 after solder completion.

One of ordinary skill in the art would appreciate that solder material used in the program controlled automatic solder system may be a conductive paste pre-printed on the product 500, an alloy solder pre-fused or melted on the product 500, or a welding wire fed to the product 500 during the soldering.

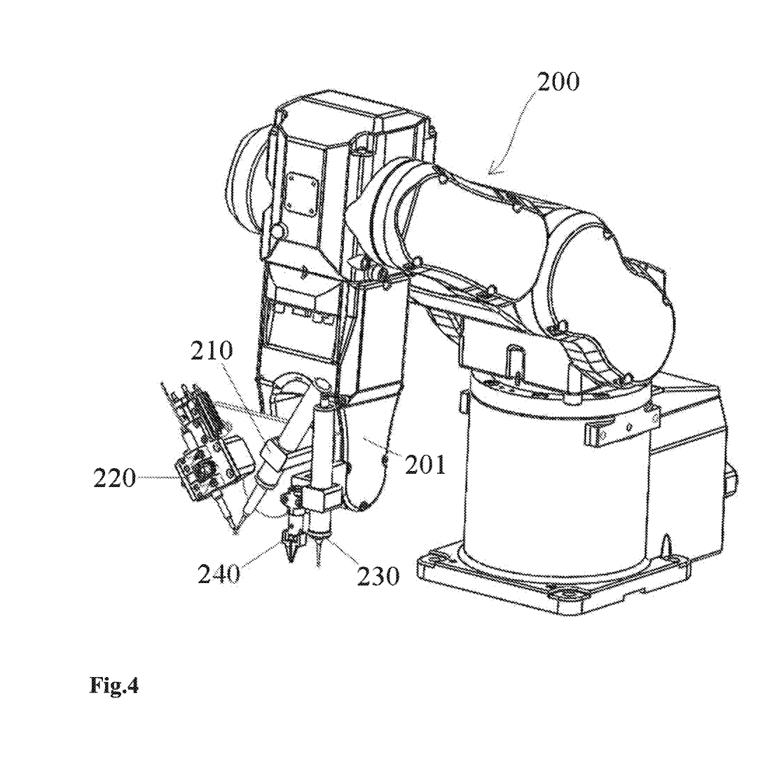

In the embodiments of FIGS. 2 and 4, the solder material is a welding wire fed to the product 500 during the soldering. The automatic soldering system further includes a welding wire feeding mechanism 220 mounted, for example, on the second manipulator 200. The welding wire feeding mechanism 220 feeds the welding wire to the location where the product 500 is to be soldered, under the guidance of the vision system 300.

In the embodiments of FIGS. 2 and 4, the program controlled automatic soldering system includes a flux applicator 230 mounted, for example, on the second manipulator 200. The flux applicator 230 applies a flux coating on the location of the product 500, under the guidance of the vision system 300, prior to heating the welding wire.

In an exemplary embodiment, the object grasped by the first or second gripper is a pin to be soldered on the product 500, and/or a conductor wire to be soldered on the pin of the product 500. In an embodiment, the second gripper would be mounted on the first manipulator 100. In the embodiments of FIGS. 1-4, the object is the conductor wire to be soldered on the pin of the product 500.

As seen in the embodiments of FIGS. 2 and 4, the automatic soldering system further includes a cutting mechanism 240 mounted, for example, on the second manipulator 200. The cutting mechanism cuts the conductor wire to a predetermined length under the guidance of the vision system 300.

In the embodiments of FIGS. 1-4, the third gripper is mounted on the first manipulator 100, and the welding wire feeding mechanism 220, the flux applicator 230 and the cutting mechanism 240 are mounted on the second robot 200.

In FIG. 4, the welding wire feeding mechanism 220, the flux applicator 230 and the cutting mechanism 240 are mounted on the second terminating arm 201 of the second robot 200.

In an embodiment of FIG. 4, the heater 210 and the welding wire feeding mechanism 220 are mounted on a first installation plate (not shown), which is fixed on the second terminating arm 201 of the second robot 200. The flux applicator 230 and the cutting mechanism 240 are mounted on a second installation plate (not shown), which is also fixed on the second terminating arm 201 of the second robot 200. In an embodiment, the first installation plate is positioned substantially perpendicular to the second installation plate.

In view of the above embodiments, one of ordinary skill in the art would appreciate that other embodiments are within the scope and spirit of the invention. For example, the welding wire feeding mechanism 220, the flux applicator 230, the cutting mechanism 240 and the third gripper may be mounted on different manipulators 100,200, or at least two of the welding wire feeding mechanism 220, the flux applicator 230, the cutting mechanism 240 and the third gripper may be mounted on the same one manipulator.

In an embodiment of FIG. 1, the vision system 300 includes at least one charge coupled device (CCD) camera. In another embodiment, the vision system 300 includes two or more CCD cameras positioned so that optical axes of the CCD cameras are perpendicular to each other.

Although it is not shown, on of ordinary skill in the art would appreciate that in an embodiment, the product supporting base 400 may be mounted on a third manipulator, for example, a rotation mechanism or a translation mechanism. In this embodiment, after completing the soldering on a first location of the product, the third manipulator may move the product, so that a second location of the product to be soldered reaches a target position to perform soldering operation on the second location. The third manipulator may be provided if locations of the product to be soldered are arranged in a regular pattern, for example, in a circle or in a line by an even interval. In this embodiment, the third manipulator can simply and accurately move the locations of the product to be soldered to the target position one by one, sequentially. In this way, the soldering efficiency is increased by omitting the step of visually identifying the locations of the product through of the vision system.

In an embodiment, the heater 210 is a soldering iron head.

In an embodiment, the cutting mechanism 240 is a scissor-type cutter.

In the embodiment of FIG. 1, the first robot 100, the second robot 200 and the product supporting base 400 are mounted on the same work platform 10, for example, a top platform of a movable cabinet. Support legs and wheels are installed on bottom of the movable cabinet. To move the cabinet, the support legs may be retracted, to rest the cabinet on the wheels.

In an embodiment (not shown), the program controlled automatic soldering system further includes a control device, such as an industrial personal computer. The control device may be positioned in the movable cabinet to protect the control device from the dust and moisture.

The soldering process of the program controlled automatic soldering system will now be discussed, with reference to FIGS. 1-4.

Firstly, the first gripper 110 mounted on the first robot 100 grasps one conductor wire, and places and holds an end of the conductor wire on the first location of the product 500 to be soldered, under the guidance of the vision system 300;

Secondly, based on the identification of the vision system 300, the length of the conductor wire is checked to verify the length is equal to the predetermined length. If the length of the conductor wire is longer than the predetermined target length, the cutting mechanism 240 mounted on the second robot 200 cuts the conductor wire to the predetermined length, under the guidance of the vision system 300.

Thirdly, the flux applicator 230 mounted on the second robot 200 coats the flux on the location of product 500 to be soldered, under the guidance of the vision system 300.

Fourthly, the welding wire feeding mechanism 220 mounted on the second robot 200 accurately feeds the welding wire to the location of product 500 to be soldered, under the guidance of the vision system 300.

Lastly, the heating portion of the heater 210 mounted on the second robot 200 is placed on the location of the product 500 to heat the welding wire thereon, and solder the conductor wire to the product 500. Again, the positioning of the heater 210 is done under the guidance of the vision system 300

After completing the soldering of the first location of the product 500, the above steps can be repeated to solder the next location of the product 500 to be soldered, until all locations of the product 500 to be soldered have been soldered.

Those skilled in this art would appreciate that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising”, including” or “having” an element or a plurality of elements having a particular property may include additional such elements not having that property.

What is claimed is:

1. A program controlled automatic soldering system, comprising:
a vision system;
a first manipulator controlled by the vision system, and having a first gripper; and
a second manipulator controlled by the vision system, and having a heater.

2. The program controlled automatic soldering system of claim 1, wherein the first gripper grasps an object to be soldered on a product.

3. The program controlled automatic soldering system of claim 2, wherein the heater is in contact with a solder material.

4. The program controlled automatic soldering system according to claim 1, wherein an object to be soldered is positioned at a predetermined location on the product by the gripper.

5. The program controlled automatic soldering system according to claim 1, further comprising a product supporting base.

6. The program controlled automatic soldering system according to claim 3, wherein the solder material is a pre-printed conductive paste, a pre-fused or melted alloy solder, or a welding wire.

7. The program controlled automatic soldering system according to claim 3, further comprising a welding wire feeding mechanism mounted on the first or second manipulator and controlled by the vision system.

8. The program controlled automatic soldering system according to claim 7, further comprising a flux applicator mounted on the first or second manipulator and controlled by the vision system.

9. The program controlled automatic soldering system according to claim 6, wherein the object is a pin to be soldered on the product, or a conductor wire to be soldered on the pin of the product.

10. The program controlled automatic soldering system according to claim 9, wherein the first gripper is mounted on the first manipulator and the conductor wire or pin is held in the first gripper.

11. The program controlled automatic soldering system according to claim 10, further comprising a second gripper mounted on the first manipulator and the conductor wire or pin is held in the second gripper.

12. The program controlled automatic soldering system according to claim 11, further comprising a cutting mechanism mounted on the first or second manipulator.

13. The program controlled automatic soldering system according to claim 12, wherein the conductor wire has a predetermined length defined by the cutting mechanism being controlled by the vision system.

14. The program controlled automatic soldering system according to claim 13, further comprising a third gripper mounted on the first or second manipulator and controlled by the vision system.

15. The program controlled automatic soldering system according to claim 14, wherein the product is positionable on the product supporting base by the third gripper.

16. The program controlled automatic soldering system according to claim 15, wherein the welding wire feeding mechanism, the flux applicator, and the cutting mechanism are mounted on the second manipulator.

17. The program controlled automatic soldering system according to claim 15, wherein the welding wire feeding mechanism, the flux applicator, the cutting mechanism, and the third gripper are mounted on the first or second manipulators.

18. The program controlled automatic soldering system according to claim 15, wherein at least two of the welding wire feeding mechanism, the flux applicator, the cutting mechanism, and the third gripper are mounted on the same manipulator.

19. The program controlled automatic soldering system according to claim 1, wherein the vision system includes at least one camera.

20. The program controlled automatic soldering system according to claim 15, wherein the first and second manipulators are multi-freedom robots.

21. The program controlled automatic soldering system according to claim 20, wherein the first and second manipulators include a terminating arm.

22. The program controlled automatic soldering system according to claim 21, wherein the welding wire feeding mechanism, the flux applicator, the cutting mechanism, the first gripper, the second gripper, and the third gripper mount on the terminating arms of the first or second manipulator.

23. The program controlled automatic soldering system according to claim 22, further comprising a third manipulator.

24. The program controlled automatic soldering system according to claim 23, further comprising a product supporting base mounted on the third manipulator.

25. The program controlled automatic soldering system according to claim 2, wherein the product is a printed circuit board.

26. The program controlled automatic soldering system according to claim 1, wherein the heater is a soldering iron head.
